(19) United States
(12) Patent Application Publication
(10) Pub. No.: US 2006/0164534 A1
(43) Pub. Date: Jul. 27, 2006

(54) High-speed digital video camera system and controller therefor

(76) Inventors: Christopher Paul Robinson, Basildon (GB); Timothy Nicholas Dammery, Leigh-on-Sea (GB); Nicki John Paris, Essex (GB)

Correspondence Address: Smith Gambrell & Russell, 1850 M Street N W, Suite 800, Washington, DC, 20036, US

(21) Appl. No.: 10/547,640

(22) PCT Filed: Feb. 27, 2004
(86) PCT No.: PCT/GB04/00796

§ 371 Date: Sep. 1, 2005

(30) Foreign Application Priority Data
Mar. 3, 2003 (GB) 0304804.8

(51) Int. Cl. H04N 5/222

(52) U.S. Cl. 348/333.01

(57) ABSTRACT

A high-speed digital video camera (3) and controller display unit (CDU) (5) therefor are disclosed. The CDU (5) comprises a display screen (50) and a control console having one or more control elements (54, 56). The CDU (5) is adapted to be connected to the camera (3) by means of a controller display interface (32) of the camera (3), and to display video images received from the camera without storing video image data locally to the CDU. The images are preferably displayed substantially immediately by the CDU (5). The camera (3) contains the main image processing hardware, so that the CDU (5) may be highly portable and easily connected to the camera for immediate use. A high-speed digital video camera system (1) and a method of controlling the same are also disclosed.

The present invention relates to a high-speed digital video camera system. The invention also extends to a controller for use in such a system.

High-speed digital video cameras are well known in industry for their use in analysing events or processes which the human eye, or a conventional video camera, is unable to capture with sufficient detail. The range of uses of high-speed video cameras extends to the fields of combustion and detonation events, robotic operations, high-speed mechanical operations timing analysis, ballistics testing, swing analysis in sports such as tennis or golf, liquid and gas flow investigations, and vehicle impact testing.

High-speed digital video cameras usually employ a CCD (charge-coupled device) or a CMOS image sensor array, with full-frame resolutions extending into the megapixel range. The frame rate of such cameras may usually be set at between 20 fps (frames per second) and 1,000 fps for full-frame imaging and up to 10,000 fps or more for partial-frame imaging. The recorded camera images are normally stored in DRAM, rather than on moving film or tape, due to the inherent speed constraints of moving mechanical parts. This memory tends to be the limiting factor in determining the maximum recording time of a camera system. A camera therefore needs to be configured appropriately, in order to maximise the recording time and recorded image quality, as required by any particular desired application.

As will be appreciated, in order to configure a high-speed digital video camera for any particular scene to be recorded, there is a large number of variables which need to be set. These include, among others, the frame rate, frame size, shutter speed, and camera focus. In addition, the recorded image playback and saving functions of a camera system both require further operator controls.

Prior art high-speed digital video camera systems have taken a number of approaches to controlling the operation of the camera.

A first system, such as the SpeedCam or the SpeedCam Pro (manufactured by Weinberger GmbH), employs a control box which is connected by a cable to a remote camera head. The control box contains all of the processing electronics of the camera system. That is, the control box contains hardware such as a PC circuit board and a PCI card containing the camera electronics. The control box may also include a monitor, or this may be provided separately. The camera head of such systems is usually relatively small. However, the control box, incorporating the PC hardware, camera electronics and monitor, tends to be rather bulky and usually requires further interfaces, such as a keyboard and a mouse.

A second system, known as a PCI camera, consists of a remote camera head, connected by a cable to a PCI card containing the camera electronics. One such camera is the MotionScope PCI camera (manufactured by Redlake MASD, Inc.). A separate PC, or laptop, is required to operate the camera, by connecting the PCI card to the printed circuit board of the computer. In addition, the computer requires custom software, which enables it to display the video image in a window on the computer monitor and to control the camera in response to user instructions. Again, such a system requires the use of a bulky PC or laptop and may additionally need a keyboard and mouse. Furthermore, the user must fit the PCI card to the computer before use and is then limited to use of the camera only with that computer and with the appropriate software installed.

A third high-speed video camera system, known as an all-in-one or self-contained camera is such that the camera electronics, along with the imaging hardware of the camera, are contained within the camera itself. This approach is used in the Phantom camera series (manufactured by Vision Research, Inc.). A high-speed interface, such as FireWire, is used to connect the camera to a PC or laptop, which then displays the image and controls the camera. The computer in this system, using suitable software, performs all of the calculations and control decisions of the system and then sends appropriate commands to the camera. This system therefore requires the use of a bulky computer and other peripheral devices mentioned above. In addition, the computer of this system does not display real-time video footage, since the video data is transmitted asynchronously from the camera to the computer, in small data packets. This results in the timing of the image display being uncertain, depending on the size and speed of transmission of the individual video data packets.

Another type of all-in-one camera has a high-speed video memory and a microprocessor built in to the camera itself. One such camera (manufactured by Redlake MASD, Inc.) may be connected to a remote control, consisting of push button switches and LEDs (light-emitting diodes). This may be used to control some of the camera functions, but a TV monitor, PC or laptop is still required to enable image viewing.

Another all-in-one camera (manufactured by Weinberger GmbH), also has a remote control for camera operation, but its use is tied to dedicated switches on the camera itself. This means that only partial functionality of the camera may be controlled remotely, since some of the camera functions may be accessed only by means of the camera itself. It is often undesirable to approach a camera during or after imaging, because of the operating conditions in some applications.

Two further all-in-one cameras, the MotionXtra HG100K and MotionXtra CR2000 (manufactured by Redlake MASD, Inc.), also include remote controls. The HG100K has an optional tablet style display control unit, to enable set-up of remotely located cameras. The CR2000 has a handheld keypad, similar to a PDA (personal digital assistant), which provides access to some, but not all, of the features of the system. However, in order to obtain full-feature video with these units, they must either be connected to a PC, as above, or the data must be first written to a memory card and then viewed via a PC.

The problem with the above camera systems is that, in order to provide a fully functioning high-speed digital video camera system, they each require the use of numerous devices in addition to the camera itself. This results in complex, often bulky arrangements, for which many cables (for both powering and connecting the devices) are needed. For many applications, this is highly undesirable, in terms of the time taken to configure such systems (including the switch-on time for a PC), the low portability of these systems, and the requirement for many power points for the devices. There is a great number of uses for high-speed digital video cameras and many of these applications would benefit from fast and easy set-up and high portability of the camera system, with the capacity for real-time viewing and immediate, easily visible video playback.

The present invention aims to address the above objectives by providing an improved high-speed digital video camera system and method for controlling the system.

According to a first aspect of the present invention, there is provided a controller display unit (CDU) for a high-speed digital video camera, comprising a display screen and a control console having one or more control elements, wherein the CDU is adapted to be connected to a high-speed digital video camera and to display video images received from the camera without storing video image data locally to that CDU.

Providing a unit on which video images may be displayed without the need to store video image data in the unit offers the advantage of so-called real time viewing of a scene being imaged by a high-speed video camera and playback of recorded video footage. This also greatly simplifies the electronics required in the CDU, since no data storage and very little processing hardware is required. The high-speed video camera intended for use with the CDU contains all of the main image processing hardware, which means that the CDU is highly portable and easily connected to such a camera for immediate use.

Preferably, video image data are received by the CDU such that the video images are substantially immediately displayed by the CDU. This allows a user to take high-speed video footage almost anywhere and to review the footage immediately, in order to be able to select clips which are to be saved.

In a preferred embodiment, the CDU is adapted to receive and display graphical overlay data, the data being indicative of one or more functions of the camera. Alternatively or additionally, the CDU is adapted to transmit a control signal to the camera in response to a user operation of one of the control elements. Preferably, the control signal is representative of the control element operated. This has the advantage of enabling a user to observe the effect of his control actions instantly, thereby enhancing user-friendliness. The on-screen display of available options also facilitates understanding of a camera's performance parameters. The use of control signals which indicate the control key operated, rather than a specific, dedicated function to be performed, offers the advantage of easy navigation through a camera menu and fast operation of the CDU interface.

Preferably, the video image data received by the CDU are in a low-voltage differential signalling (LVDS) form and the CDU further comprises a LVDS receiver chip interfacing with the display screen. This offers high-speed, serial digital data transfer to the CDU, for an optimum display rate.

In a preferred embodiment, the CDU is adapted to be connected to a camera by means of a single cable interface, the cable being adapted to carry signals in both directions and to carry power from the camera to the CDU. This advantageously reduces the number of cables required for operation of the CDU with a camera, reducing set-up time, the number of power supply points needed and obstacles, which may hinder filming and user accessibility.

According to a second aspect of the present invention, there is provided a high-speed digital video camera, comprising an image sensor, adapted to detect an image to be viewed and recorded; a video memory within the camera, adapted to store at least temporarily image data derived from the image sensor; a camera microprocessor within the camera, adapted to process data received in the camera; and a controller display interface, adapted to be connected to a controller display unit (CDU) and to transmit video image data to the CDU for display by the CDU without storing the video image data locally to that CDU.

In a preferred embodiment, the camera further comprises a feature connector interface, adapted to be connected to a trigger device and to receive trigger signals for controlling a start or stop of a camera record function. Additionally or alternatively, the camera may comprise a computer interface, adapted to be connected to a computer and to transmit the video image data to the computer for downloading, playing back and saving by the computer, or receiving control signals from the computer. Preferably, the camera is adapted to interpret signals received through each of the respective interfaces differently and, where requested, to return data to the appropriate interface. Preferably, the feature connector interface is further adapted to be connected simultaneously to a plurality of devices and to receive one or more of a trigger signal, an analogue signal, and a camera timing synchronization signal, and to transmit one or more of a video image signal and a camera timing synchronization signal. This advantageously offers a highly multi-functional camera, which may be used in many different modes. The choice of user interface affords a user great flexibility in the precise set-up of the camera, which may vary greatly according to the desired application of the camera.

Preferably, the camera has a PCMCIA slot, for saving selected video image data to a removable memory. This allows more video footage than can be stored in the camera alone to be saved, without the need to download to a bulky computer.

According to a third aspect of the present invention, there is provided a high-speed digital video camera system, comprising i) a high-speed digital video camera, comprising an image sensor, adapted to detect an image to be viewed and recorded; a video memory within the camera, adapted to store at least temporarily image data derived from the image sensor; a camera microprocessor within the camera, adapted to process data received in the camera; and a controller display interface; and ii) a CDU, comprising a display screen; and a control console having one or more control elements, wherein the CDU is connected to the controller display interface of the camera, the camera being adapted to transmit video image data to the CDU and the CDU being adapted to display video images received from the camera without storing the video image data locally to that CDU.

According to a fourth aspect of the present invention; there is provided a method of controlling a high-speed digital video camera system, comprising i) a high-speed digital video camera, comprising an image sensor, adapted to detect an image to be viewed and recorded; a video memory within the camera, adapted to store at least temporarily image data derived from the image sensor; a camera microprocessor within the camera, adapted to process data received in the camera; and a controller display interface; and ii) a CDU, comprising a display screen; and a control console having one or more control elements, the method comprising the steps of a) transmitting video image data from the camera to the CDU; and b) displaying on the display screen video images received from the camera by the CDU without storing the video image data locally to that CDU.

Preferably, the camera is controlled solely with the CDU. This advantageously provides a highly portable system, which is simple to use and does not require extra peripheral devices or cables.

Preferably, a start or stop signal of the camera record function is received as a trigger signal from either a CDU control element operation, a trigger device, or a second camera connected to the camera, the second camera generating and transmitting to the camera a trigger signal when the second camera has reached a pre-defined stage in recording. This provides the option of daisy-chaining high-speed video cameras together, so that once one camera has filled its memory capacity, the next camera begins to record and so on. Alternatively, a scene may be recorded in synchronization from many different angles and locations.

Other preferred features are set out in the dependent claims which are appended hereto.

The present invention may be put into practice in a number of ways and some embodiments will now be described, by way of example only, with reference to the following figures, in which:

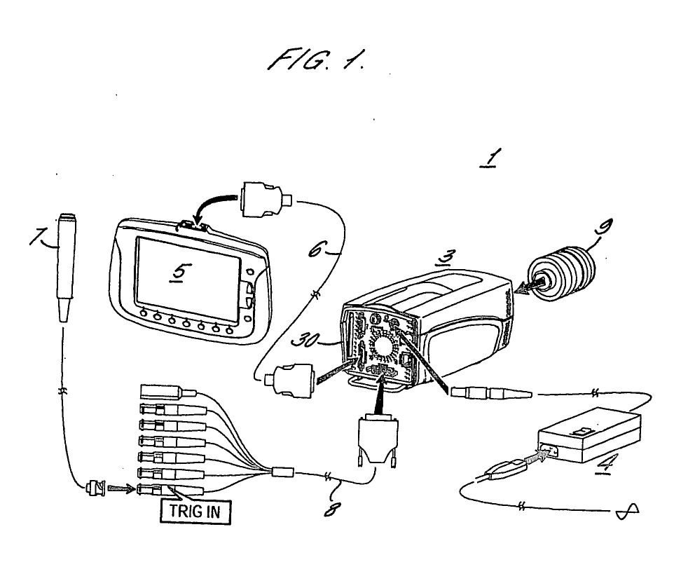

FIG. 1 shows a schematic representation of a high-speed digital video camera system embodying the present invention, including a high-speed digital video camera and a controller display unit (CDU);

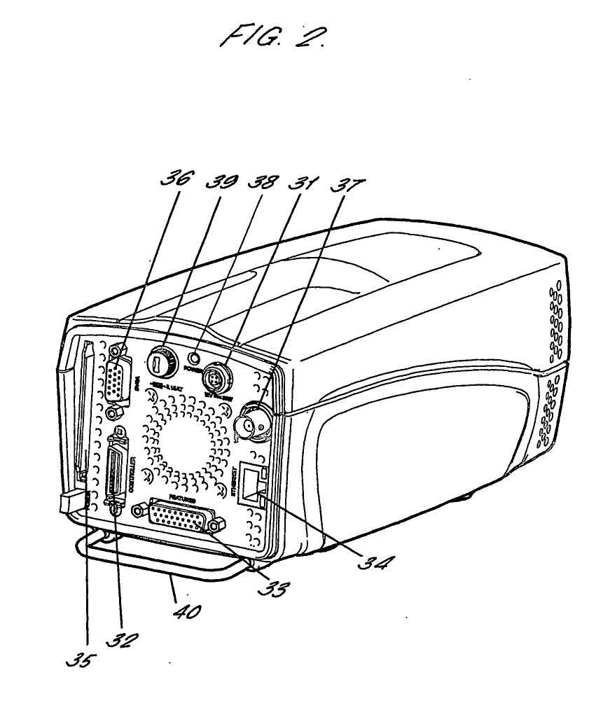

FIG. 2 shows a rear and side view of the camera of FIG. 1;

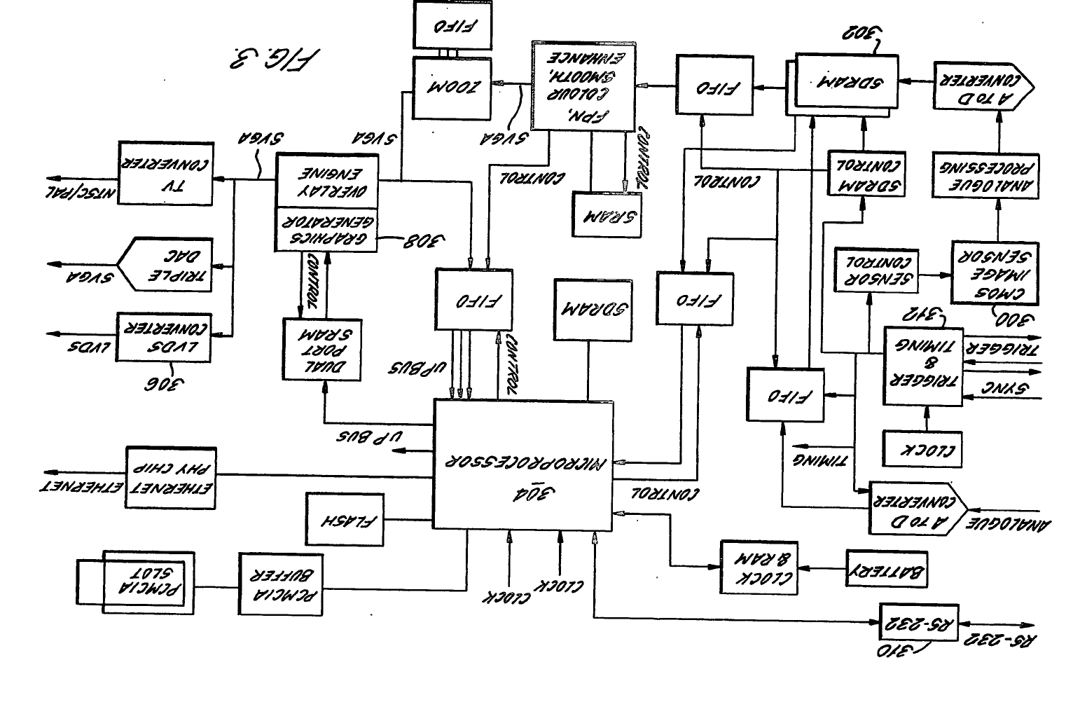

FIG. 3 shows a schematic block circuit diagram of the high-speed digital video camera of FIG. 2;

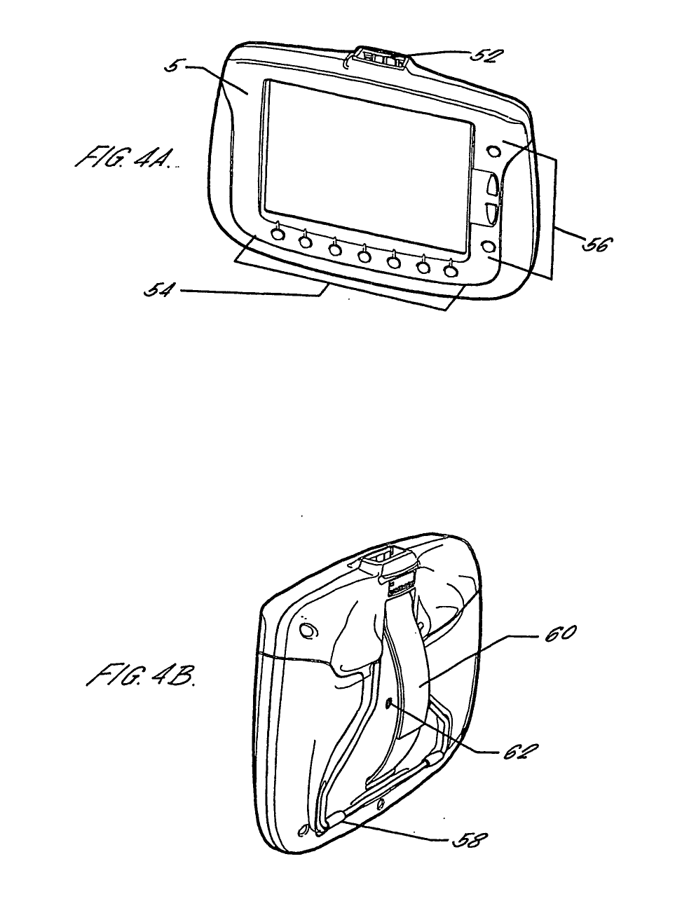

FIG. 4A shows a front view of the CDU of FIG. 1;

FIG. 4B shows a rear view of the CDU of FIG. 1;

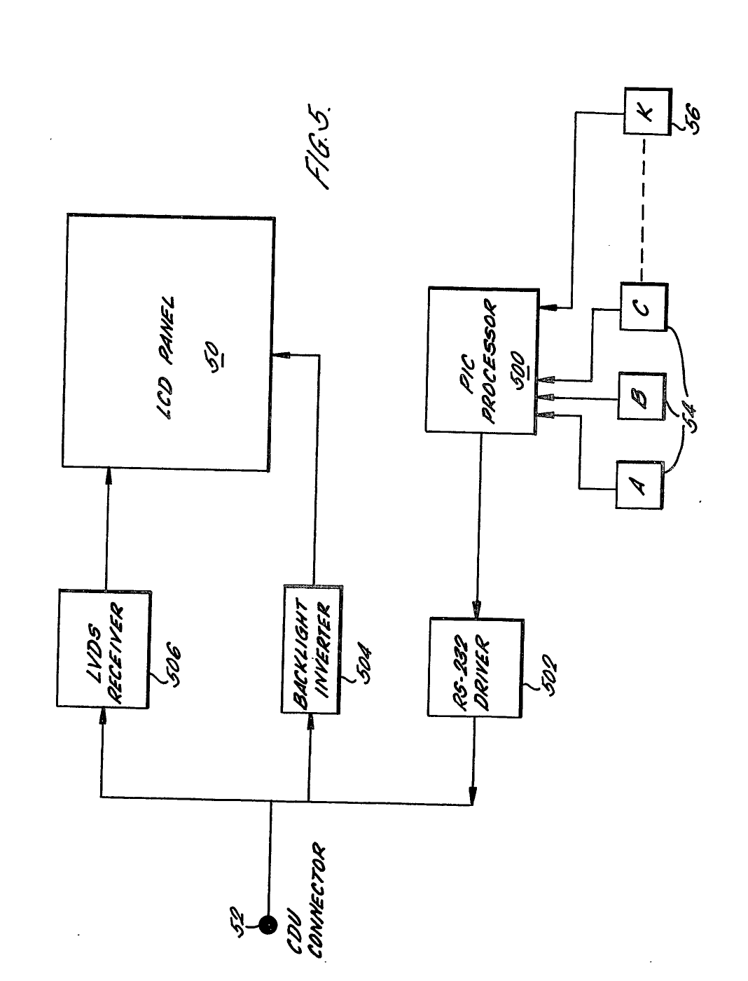

FIG. 5 shows a schematic block circuit diagram of the CDU of FIGS. 4A and 4B; and

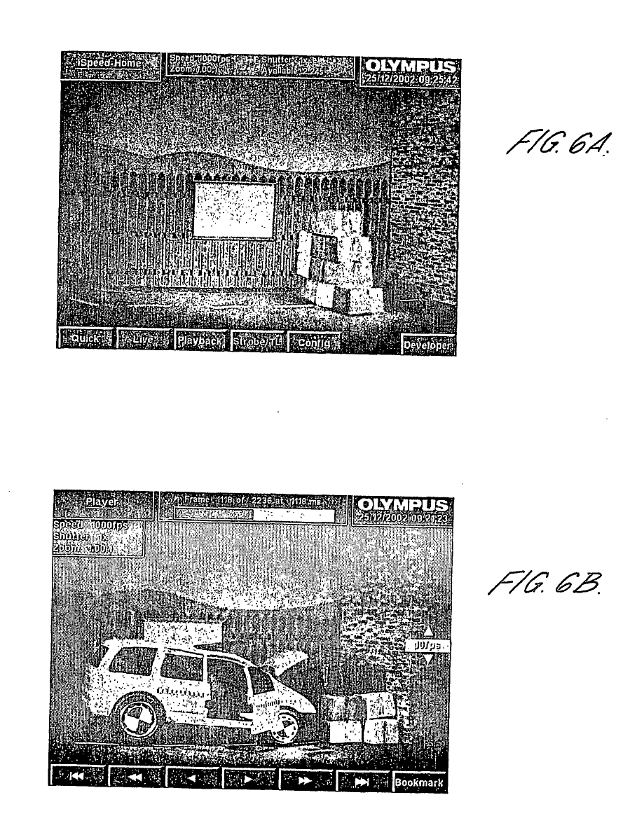

FIGS. 6A and 6B show, in black and white, exemplary display screen outputs of the CDU of FIGS. 4A and 4B.

FIG. 1 illustrates an embodiment of a high-speed digital video camera system 1 of the present invention. The system 1 includes at least a high-speed digital video camera 3 (hereinafter referred to simply as a camera 3) and a controller display unit (CDU) 5. FIG. 1 also shows a trigger switch 7, connected to the camera 3 by a feature connector cable 8. The camera 3 is powered by a power supply unit (PSU) 4 and is connected to the CDU 5 by a controller cable 6.

Referring to FIG. 2, the camera 3 has a rear panel 30, which incorporates the camera interfaces. The rear panel 30 has, among other interfaces, a power connector 31 for receiving the PSU cable. This is the main source of power to the camera 3 and also to the CDU 5, which is connected to a controller connector 32 in the rear panel 30 by the controller cable 6. In addition to carrying power from the controller connector 32, the controller cable 6 also carries video signals to the CDU 5 and button press signals from the CDU back to the controller connector, as will be described below. The camera 3 also has a built-in battery (not shown) for the purposes of retaining information, such as date, time, language of operation etc., which would otherwise be lost when the camera is switched off.

The feature connector cable 8 is connected to the camera 3 by a feature connector 33. In order to save space on the rear panel 30, the feature connector 33 is able to receive a number of different signals from various peripheral devices.

Once a video sequence has been recorded, it may be desirable to download the sequence to a PC or laptop for playback or saving. For this purpose, a standard RJ-45 Ethernet socket 34 is provided on the rear panel 30. It will be understood by the skilled reader that any other suitable form of connection, wired or wireless, such as FireWire (IEEE1394), USB (universal serial bus), or Bluetooth, may alternatively be employed.

The rear panel 30 also has a PCMCIA slot 35 for storing video data onto a flash memory card. In addition, there is a SVGA connector 36 for connection to an optional, additional monitor for viewing purposes. A composite video BNC connector 37, providing standard PAL or NTSC composite colour video to another, optional video monitor unit is also provided. The video available from the connector may be switched between NTSC and PAL via the menu system in the CDU. Finally, there is a power LED 38 and a fuse 39.

In order to protect the connectors when the camera 3 is in use, a protective bar 40 is provided at the base of the rear panel 30. This prevents damage to the connectors, for example, should the camera 3 be pushed back against a wall when in storage.

The basic layout of the hardware of the camera 3 of FIG. 2 will now be described, with reference to FIG. 3. The camera 3 has a CMOS image sensor 300, with a full-frame resolution of just under 0.5 megapixels. The sensor 300 has an active pixel structure allowing for a synchronous rather than conventional rolling shutter, such that all pixels in the sensor array receive light for the same time period. This is essential for high speed operation, as otherwise motion blur is experienced, due to the pixels not all being reset at the same time. A serial programming interface allows a randomly positioned sub-window of the full array to be read out, in order to increase the frame rate of the camera 3.

Image data received by the sensor 300 are digitized by the camera and then stored in its internal circular buffer memory 302, consisting of SDRAM. Because of the inherent limitation on the memory capacity of any high-speed digital video camera, only a pre-defined sampling time may be recorded for any specified frame size and frame rate. The memory 302 is therefore configured in a circular buffer, so that, once the memory has been filled for the first time in a recording sequence, each new image to be stored replaces the oldest stored image in the memory. This process can then continue indefinitely, until a desired event has occurred and the camera receives a signal to stop recording.

The total number of pixels the image sensor 300 can process each second is such that, in this embodiment, the camera 3 can record at a frame rate of 1,000 fps at full-frame resolution for about 9s. If faster operation is required, the number of pixels per frame must be reduced. This is achieved by reducing the active area of the image sensor 300, a process called windowing. There are three options for windowing: cutting out the vertical edges of the scene, cutting out the horizontal edges of the scene, or cutting out both to leave a central ‘square’. This permits partial-frame sequencing at rates up to a maximum of 33,000.

As indicated above, the video sequence stored in the camera's circular buffer 302 is displayed on the CDU, either as a recording playback or as real-time video. A camera microprocessor 304 controls the operation of the electronics inside the camera 3, in response to data received, both from internal and external sources. From the circular buffer memory 302, the video image data is processed in a manner known to those skilled in the art. This includes correction for fixed-pattern noise, video image enhancement and smoothing, and colour processing.

The camera 3 generates a video image which is a SVGA image, timed to match the PC standard. This is an analogue standard, but has accurate timings because it carries signals which are reconstructed from a digital data stream. The camera 3 creates a progressive, scanned 800×600 image data in, 3 colour channels (RGB). The data represent a digital version of the required analogue image. This digital data stream is used for the CDU 5.

The video image data derived from the image sensor 300 is then converted into low-voltage differential signalling (LVDS) by a converter 306. Data from the converter 306 may then be transferred to the CDU 5, via the controller connector 32 as a high-speed serial data stream.

LVDS has a number of advantages. Data are converted from parallel to serial, which affords a great reduction in the number of wires required. Although the data-rate is much increased as a result, signal integrity is preserved by sending the data differentially. Electromagnetic interference (EMI) is also reduced, since the LVDS signal amplitude is only 0.35V. A LVDS link is able to support cable lengths of up to 10 metres.

The LVDS converter 306 converts four 7-bit parallel video data streams, derived from the image sensor 300, plus a 40 MHz clock signal into four serial data streams, plus the clock signal. The output data-rate and clock frequency therefore need to be synthesised at seven times the input rate, which in this embodiment is 280 Mbit/sec. This is achieved with a phase-locked loop (not shown) on the LVDS converter chip, incorporating a divide-by-7 in its feedback loop. The LVDS data are fed to the controller connector 32 via a number of dual common-mode filters (not shown), for the purpose of EMI reduction.

In addition to the video image data transferred to the CDU 5 in this way, the camera also sends graphical overlay data. This data is produced by a graphics generator and overlay engine 308, under control of the microprocessor 304 in the camera 3. The graphical overlay represents the camera functions available for selection by a user, in the context of use of the camera 3. This overlay is therefore variable, and depends on the particular function the camera is performing at any one time. When a user wishes to select a different function from the one the camera 3 is performing, the user may send a control signal to the camera. In the present embodiment, this control signal is in the form of an RS-232 signal, which is received by a RS-232 receiver chip 310 and then transmitted to the microprocessor 304. The microprocessor 304 then determines the desired function to be performed and requests the appropriate video image data from the memory 302, which is transmitted to the LVDS converter 306 for transfer to the CDU 5, along with a new graphical overlay, as required by the new camera function.

One such function available for selection by a user is the camera's record mode. In this mode, the camera 3 will store video image data in its circular buffer memory 302 indefinitely, until a signal is received by the camera 3 to stop recording. The method of stopping the camera 3 is highly important as it is this which determines which part of a video sequence is captured. There are two methods of stopping the record mode of the camera 3. The first is a button press in the menu system of the CDU 5, which immediately stops the recording process, so that the memory 302 contains the video history immediately prior to the button press. The second method is to use an external electrical trigger signal, which causes the camera 3 to stop recording after a user-settable delay. The trigger signal is received by a trigger and timing module 312 in the camera 3. By permitting the camera to record for a pre-defined period after the trigger signal, some of the video sequence stored before the trigger signal, along with some subsequently recorded video footage, may be preserved in the memory. In this way, the trigger signal may occur in the middle of the event of interest and yet the camera may still record the whole event.

The delay between the trigger event and the cessation of recording is controlled by a frame counter, known as the trigger counter. The duration of this count may be set from anywhere between 0% and 100% of the total available record time of the camera's memory.

The camera 3 has two extensions to the normal trigger operation described above. These are called Record On Command (ROC) and Burst Record On Command (BROC). Once recording mode is selected in the ROC mode, the camera only records video into the memory while the trigger signal is true (that is, at active low). By judicious use of the trigger connection (e.g., dextrous use of the trigger switch 7) the camera 3 may record several short bursts of video into the memory buffer 302. For the purposes of ROC and BRQC, the memory is not treated as a circle, but is regarded as being linear and having a defined start and end. This has the effect that when the memory 302 is full, no further recording is possible. A facility is provided through the CDU 5 to erase individual video bursts from the memory 302, in case of erroneous recording, and a further facility is provided to erase the entire memory 302. BROC is an extension of ROC, in that a trigger edge (rather than an active level) will cause the camera 3 to record video images for a pre-defined period of time. In this case, the length of time over which the trigger signal is active is ignored by the trigger and timing module 312. This function is especially useful for unattended operation, when several short events are likely to occur. The burst time is settable in the menu system, using the CDU 5.

FIG. 3 illustrates a number of other features which will be familiar to those skilled in the art and which, for the purpose of conciseness will not, therefore, be described in further detail.

Referring now to FIGS. 4A and 4B, the CDU 5 of this embodiment of the present invention will be described in detail. The CDU 5 is a hand-held device, for use in displaying video images and controlling the camera 3. The CDU 5 displays the video images on a high-resolution, built-in, colour TFT LCD screen 50 and allows camera functions to be controlled remotely via a graphical user interface (GUI). The controller cable 6 may be connected to the CDU 5, using the controller connector 52. The CDU 5 takes power and video from the camera 3 and requires no batteries or further connections in order to operate. The LCD screen 50 has a native resolution of 800×600 pixels (SVGA) and also requires a frame refresh rate and pixel rate equal to the optional SVGA video output from the camera 3. This means that no scaling or format conversion electronics are required in the CDU 5, thereby greatly reducing circuit complexity, power consumption and cost. The LCD screen 50 requires 18-bit RGB video (i.e., 6-bits per colour), which is achieved by dropping the two LSBs (least, significant bits) of each colour from the digital video signal in the camera 3. This is carried out in the camera 3, just before the video image data are converted to analogue signals, for output to an optional SVGA monitor (not shown).

Around the bottom and right-hand edges of the LCD screen 50, there are a plurality of camera control buttons 54, 56. In order to increase the flexibility of use of the CDU 5, there are seven such buttons along the bottom edge of the LCD screen 50, each of these buttons being a ‘soft key’ 54, that is, the function of each soft key 54 is not fixed. Instead, the function is determined by the camera microprocessor 304 and indicated by the graphical overlay above each soft key 54 on the LCD screen 50. The four buttons on the right-hand side of the CDU 5 are called function keys 56, having dedicated functions. From top to bottom when viewed in FIG. 4A, these are: text off (that is, graphical overlay off), up, down (that is, referring to a quantity to be set in the particular functional context), and back (that is, return to the next highest menu). The menu system produced by the graphics generator and overlay engine 308 is designed to correspond to the layout of the control buttons 54, 56.

Referring to FIG. 4B, the CDU 5 is equipped with a stand 58, which may be set to a number of ‘click-stop’ positions. This permits the CDU 5 to be stood on a flat surface at various angles or hung from a convenient hook or other support. The stand 58 may also be folded flat for storage. The back of CDU 5 also has an adjustable strap 60, which may be used to allow the unit to be conveniently held with a single hand. In addition, the CDU 5 contains a tripod mounting hole 62, with the industry standard thread, which is located under the strap 60.

FIG. 5 shows a schematic block circuit diagram of the CDU 5. The CDU 5 does not contain any memory for storing video image data, since all relevant data is stored by the camera 3 and transmitted to the CDU 5 when required.

The CDU 5 contains a small microprocessor 500 (such as the PIC microprocessor, manufactured by Microchip Technology, Inc.). This microprocessor 500 converts soft key 54 and function key 56 button presses into control signals, using the RS-232 serial communications protocol, operating at 9600 baud. The momentary contact closure of a button 54, 56 is encoded into this standard using the microprocessor 500, clocked at 4 MHz. Each RS-232 control signal is transmitted to the camera microprocessor 304 by a RS-232 driver 502 in the CDU 5. Each button press produces two bytes of data: the first informs the camera 3 which device is communicating with the camera and the second indicates which button has been pressed.

For example, if the leftmost soft key 54 on the CDU 5 is pressed, a “cA<cr>” signal is transmitted to the camera microprocessor 304. The ‘c’ indicates that the control signal originates from the CDU 5; the ‘A’ indicates that the leftmost soft key 54 was pressed; and the ‘<cr>’ is a standard end-of-command carriage return. In this way, the camera microprocessor 304 determines what steps to take and which camera function to perform.

The LCD screen 50 has its own driver electronics, as will be understood by the skilled person, and the CDU 5 contains a voltage inverter 504, to generate the relatively high voltage required to drive the LCD backlight. The LCD screen 50 is back-lit using two miniature cold-cathode fluorescent (CCFL) tubes (not shown) These require about 2 kV as a starting voltage and a few tens of volts in operation. A resistor (not shown) sets the brightness of the back-light: the fitted 0 Ohms value gives a maximum, but this value can be increased up to 10 kOhms, offering progressive dimming, should this be required.

As described above, the camera 3 transmits the video image data to the CDU 5 in the form of LVDS. The video image data and clock signal transmitted by the camera 3 are at 280 MHz, that is, seven times the parallel video pixel rate. These signals all go through the common-mode filters (not shown) in the camera 3, to prevent high-speed signals generated within the CDU enclosure from being radiated from the LVDS cable 6. The CDU 5 contains a LVDS receiver chip 506, which receives the video image data and interfaces directly with the LCD screen 50, to display the video images and the graphical overlay. The LVDS receiver chip 506 converts the differential data to single-ended, before recovering the original parallel video data, synchronising signals and 40 MHz pixel clock. That is, the LVDS receiver chip 506 in the CDU 5 does exactly the opposite of the LVDS converter and transmitter 306 in the camera 3. The receiver chip 506 recovers the 280 MHz clock signal, divides it down to 40 MHz, deserializes the 4 streams of data and regenerates exactly what was originally transferred to the LVDS converter 306.

The bottom two bits of each colour (R0, R1, G0, G1, B0 and B1) are discarded by the receiver chip 506, since the LCD screen 50 requires 18-bit, rather than 24-bit, colour data. The LCD screen 50 also requires two further synchronising signals: a 4.0 MHz pixel clock, and a signal to indicate the active area of the video displayed. Horizontal and vertical synchronising signals, which are generated in the camera 3 for the other, optional video outputs, are not needed by the CDU 5. These are, however, sent over the LVDS link, being output on the camera's controller connector 32 for the purposes of future expansion.

The resulting parallel data, containing a digital replica of the analogue image, is then driven directly into the LCD screen 50. The LVDS receiver chip 506 has outputs which are designed to drive parallel data into LCD panels, so the receiver chip and LCD screen are connected by a flexible cable (not shown). The LCD screen 50 takes 6 bits from each channel and turns this into an image, as will be understood by the skilled reader.

The camera electronics are configured in such a way that the clock frequency, bus width of the controller connector 32 and image-timing circuitry of the camera 3 result in the video image data transfer rate of the camera 3 corresponding to the video image display rate of the CDU 5. The arrangement of the camera electronics in this way permit the CDU 5 to be able to display video images without the need to store them locally. This even extends to buffering memory, so that video image data transferred from the camera 3 to the CDU 5 are displayed as video images substantially immediately upon receipt by the CDU.

The principle of operation of the CDU 5 will now be described, with reference to FIGS. 6A and 6B. To navigate through the menu system, generated as a graphical overlay on the CDU screen 50, the button 54, 56 nearest the desired selection is pressed. When a camera function has been selected and a parameter is to be set, the desired value may be chosen by using the up and down function keys 56, on the right hand side of the screen 50. Repeatedly pressing these buttons 56, or pressing and holding the control button, will cycle through the available values. The current value is displayed on the screen 50, both above the soft key graphical overlay and adjacent the up/down buttons 56. To return to a higher menu, the back function key is pressed. If there is a requirement for a text free screen, the text off function key is used to cycle the on-screen text, through the full, time/date only and off options.

In order to analyse an event, a clear line of sight must be found for the camera 3. A tripod or magic arm may be required to hold the camera 3 in place. An appropriate lens 9 is chosen and fitted to the front of the camera 3. Additional lighting, with its associated tripods etc., may need to be provided. The camera 3 is switched on, and directed towards the region of interest. The frame speed and shutter setting are chosen, using the graphical overlay menu described above. The lighting and lens 9 are adjusted appropriately and the camera 3 is then placed in record mode. As described above, the camera 3 takes video at high frame rates and stores it in the camera's built-in memory 302. This memory 302 is configured in a circle so that, once the memory is full, each new frame replaces the oldest stored frame. In this way, the camera 3 keeps a rolling history of the scene in view, a process which may continue indefinitely. Once a desired event has occurred, the camera 3 is stopped or triggered. During the entire set-up and record process, the CDU 5 and any monitor optionally attached will display the live image in full colour and in real time. Once the required video clip is stored in memory 302, it may be viewed by using the camera's playback function. In this mode, video may be played forwards or backwards and at a range of speeds. A convenient bookmark system is also provided for improved navigation between sections of interest. The memory 302 in the camera 3 will be erased when the power is switched off, so if it is necessary to preserve the captured video after power off, it may be recorded onto a PCMCIA memory card, when this is inserted into the card slot 35 provided. The internal memory 302 is much bigger than any card currently available, so only a subsection of video may be stored. However, since high-speed video clips generally contain a large amount of “dead time” (that is, redundant video footage recorded before and after the event(s) of interest) and a relatively small amount of useful motion, the camera 3 has a clip select function. This function permits a precise selection of the recorded video to be saved.

FIG. 6A shows the CDU display screen 50, displaying a ‘live’ (colour) video image shortly after switch-on of the camera system 1. The CDU display screen 50 is updated at 60 fps at all times, to the SVGA video signal standard. This is independent of the rate at which a recorded video sequence is being played back. That is, regardless of whether the CDU 5 is playing back a still image (e.g., a single, selected frame from a recorded video sequence) or a moving image at a fast playback rate, the screen 50 itself will still be updated 60 times per second.

FIG. 6B shows the CDU display screen 50, displaying a recorded frame in the camera's playback mode. As in FIG. 6A, camera status information is provided by the graphical overlay at the top of the screen 50 and the camera function options are listed along the bottom of the screen.

As described briefly above, the camera 3 of the present invention is capable of connecting to other devices in a variety of ways. For example, the camera 3 may be externally triggered or synchronised, and may also record analogue electrical signals along with the video.

A remote-control pad (RCP), incorporating functional keys as described above may also be used to control the camera 3, although a separate monitor would then be required. This hand-held unit may be connected to the camera's controller connector 32 and may be powered by the camera. The RCP uses a similar circuit for encoding button presses into RS-232 serial data as the CDU 5. This indicates to the camera that the device is the RCP by prefixing each data byte with the character ‘r’. The camera 3 is then able to recognise the presence of the RCP and operates a specialised menu system, which is displayed on a PC monitor or TV monitor. The RCP may then be used to navigate the menu system. Preferably, however, the camera 3 is controlled solely with the CDU 5.

As will be understood, the camera 3 is capable of interpreting the signals received through each of the interfaces on the rear panel 30 differently and, where requested, to return data to the appropriate interface.

The trigger signal received by the trigger and timing module 312 may be transmitted by one or more trigger switches, one or more photosensors, or other suitable trigger devices. Alternatively, the trigger signal may be received from another camera recording the video sequence, either simultaneously but from a different location or angle, or at an earlier-stage in the sequence with the trigger signal indicating that the other camera has run out of memory.

Although the soft keys 54 and function keys 56 have been described as control buttons, they may alternatively be switches, dials, pads, rollers, joysticks and the like. Furthermore, the LCD screen 50 may additionally or alternatively be a touch-sensitive screen.

The above embodiments of the present invention are by way of example only. Other foreseeable alternatives or equivalents are also envisaged.

1. A controller display unit (CDU) for a high-speed digital video camera, comprising:
a display screen; and
a control console having one or more control elements,
wherein the CDU is adapted to be connected to a high-speed digital video camera and to display video images received from the camera without storing video image data locally to that CDU.

2. The CDU of claim 1, further adapted to receive video image data such that the video images are substantially immediately displayed by the CDU.

3. The CDU of claim 1, further adapted to receive and display graphical overlay data, the data being indicative of one or more functions of the camera.

4. The CDU of claim 1, further adapted to transmit a control signal to the camera in response to a user operation of one of the control elements.

5. The CDU of claim 4, wherein the control signal is representative of the control element operated.

6. The CDU of claim 4, further comprising a CDU microprocessor adapted to convert the user operation of one of the control elements into a serial control signal for transmission to the camera microprocessor.

7. The CDU of claim 6, wherein the control signal is a RS-232 signal.

8. The CDU of claim 1, wherein the video image data received by the CDU are in a low-voltage differential signalling (LVDS) form and the CDU further comprises a LVDS receiver chip interfacing with the display screen.

9. The CDU of claim 1, wherein the CDU is hand-held.

10. The CDU of claim 1, wherein the CDU has at least one of: a flip-out stand, an adjustable hand-strap, and a tripod mounting thread.

11. The CDU of claim 1, wherein the CDU is adapted to be connected to the camera by means of a single cable interface, the cable being adapted to carry signals in both directions and to carry power from the camera to the CDU.

12. A high-speed digital video camera, comprising:
an image sensor, adapted to detect an image to be viewed and recorded;
a video memory within the camera, adapted to store at least temporarily image data derived from the image sensor;
a camera microprocessor within the camera, adapted to process data received in the camera; and
a controller display interface, adapted to be connected to a controller display unit (CDU) and to transmit video image data to the CDU for display by the CDU without storing the video image data locally to that CDU.

13. The camera of claim 12, wherein the camera is adapted to transmit video image data to the CDU such that video images are substantially immediately displayed by the CDU.

14. The camera of claim 12, wherein the camera is further adapted to transmit graphical overlay data to the CDU, the data being indicative of one or more functions of the camera.

15. The camera of claim 12, wherein the controller display interface is further adapted to receive control signals from the CDU.

16. The camera of claim 15, wherein the camera microprocessor is adapted to interpret the control signals to determine the one or more functions to be performed by the camera.

17. The camera of claim 12, further comprising a feature connector interface, adapted to be connected to a trigger device and to receive trigger signals for controlling a start or stop of a camera record function.

18. The camera of claim 12, further comprising a computer interface, adapted to be connected to a computer and to transmit the video image data to the computer for downloading, playing back and saving by the computer.

19. The camera of claim 18, wherein the computer interface is further adapted to receive control signals from the computer.

20. The camera of claim 17, wherein the camera is adapted to interpret signals received through each of the respective interfaces differently and, where requested, to return data to the appropriate interface.

21. The camera of claim 17, wherein the feature connector interface is further adapted to be connected simultaneously to a plurality of devices and to receive one or more of a trigger signal, an analogue signal, and a camera timing synchronization signal, and to transmit one or more of a video image signal and a camera timing synchronization signal.

22. The camera of claim 12, wherein the camera microprocessor includes a clock having a clock frequency, and wherein the controller display interface has a bus width, each of which provides a video image data transfer rate of the camera which is matched to a video image display rate upon the CDU.

23. The camera of claim 12, further comprising a PCMCIA slot, for saving selected video image data to a removable memory.

24. A high-speed digital video camera system, comprising:
i) a high-speed digital video camera, comprising:
an image sensor, adapted to detect an image to be viewed and recorded;
a video memory within the camera, adapted to store at least temporarily image data derived from the image sensor;
a camera microprocessor within the camera, adapted to process data received in the camera; and
a controller display interface; and
ii) a CDU, comprising:
a display screen; and
a control console having one or more control elements,
wherein the CDU is connected to the controller display interface of the camera, the camera being adapted to transmit video image data to the CDU and the CDU being adapted to display video images received from the camera without storing the video image data locally to that CDU.

25.-33. (canceled)

34. A method of controlling a high-speed digital video camera system, comprising:
i) a high-speed digital video camera, comprising:
an image sensor, adapted to detect an image to be viewed and recorded;
a video memory within the camera, adapted to store at least temporarily image data derived from the image sensor;
a camera microprocessor within the camera, adapted to process data received in the camera; and
a controller display interface; and
ii) a CDU, comprising:
a display screen; and
a control console having one or more control elements,
the method comprising the steps of:
a) transmitting video image data from the camera to the CDU; and
b) displaying on the display screen video images received from the camera by the CDU without storing the video image data locally to that CDU.

35. The method of claim 34, wherein the camera transmits video image data, and the CDU receives the video image data, such that the video images are substantially immediately displayed by the CDU.

36. The method of claim 34, further comprising the step of:
c) generating and transmitting to the CDU from the camera graphical overlay data, and displaying on the display screen a graphical overlay indicative of one or more functions of the camera.

37. The method of claim 36, further comprising the step of:
d) selecting from the one or more functions represented by the graphical overlay a desired function and operating a corresponding control element.

38. The method of claim 37, further comprising the step of:
e) converting the operation of the control element into a control signal representative of the control element operated and transmitting the control signal to the camera microprocessor.

39. The method of claim 38, further comprising the step of:
f) processing the control signal received from the CDU and returning to step (a), with the video image data and/or the graphical overlay data transmitted to the CDU being changed by the camera as required.

40. The method of claim 34, wherein, in use, the camera is controlled solely with the CDU.

41. The method of claim 34, wherein the video image data are carried as a serial data stream in the form of low-voltage differential signalling (LVDS).

42. The method of claim 34, wherein a video image data transfer rate of the camera to the CDU corresponds to a video image display rate of the CDU.

43. The method of claim 36, wherein the one or more functions of the camera include one or more of:
i) setting a parameter value of the camera, such as frame speed, shutter speed, camera focus, or frame size; and
ii) starting or stopping a camera operation, such as live image feeding, recording, playing back, bookmarking, clip selecting, or saving.

44. The method of claim 43, wherein a start or stop signal of the camera record function is received as a trigger signal from either a CDU control element operation, a trigger device, or a second camera connected to the camera, the second camera generating and transmitting to the camera a trigger signal when the second camera has reached a pre-defined stage in recording.
